(19) United States
(12) Patent Application Publication
(10) Pub. No.: US 2026/0252929 A1
(43) Pub. Date: Aug. 27, 2026

(54) ARRANGEMENT FOR QUANTUM COMPUTING

(71) Applicant: IQM FINLAND OY, Espoo (FI)

(72) Inventors: Kristinn JULIUSSON, Espoo (FI); Hermanni HEIMONEN, Espoo (FI); Jami RÖNKKÖ, Espoo (FI); Jani TUORILA, Espoo (FI); Pasi LÄHTEENMÄKI, Espoo (FI); Mikko MÖTTÖNEN, Espoo (FI)

(21) Appl. No.: 18/877,131

(22) PCT Filed: May 17, 2023
(86) PCT No.: PCT/FI2023/050278

§ 371 Date: Dec. 19, 2024

(30) Foreign Application Priority Data
Jun. 22, 2022 (FI) 20225565

(51) Int. Cl. G06N 10/20; G06N 10/40

(52) U.S. Cl. CPC G06N 10/20; G06N 10/40

(57) ABSTRACT

According to an embodiment, an arrangement for quantum computing comprises: a first quantum system having a plurality of Fock quantum states comprising at least a zero-photon state, a one-photon state, and a two-photon state; and a second quantum system coupled to the first quantum system and comprising at least a ground state and one or more excited states and is configured to, via the coupling, cause at least one of the one or more excited states to hybridize with the two-photon state of the first quantum system causing the two-photon state to split into a first hybridized state and a second hybridized state, wherein an energy difference between the one-photon state and the first hybridized state is non-equal to an energy difference between the zero-photon state and the one-photon state and an energy difference between the one-photon state and the second hybridized state is non-equal to the energy difference between the zero-photon state and the one-photon state.

### TECHNICAL FIELD

The present disclosure relates to a quantum computing, and more particularly to an arrangement for quantum computing and to a quantum computing system.

### BACKGROUND

Quantum computing is based on the idea of storing information in a two-level quantum system. However, many realizations of such quantum bits (qubits) have more than two energy levels. In such cases the qubit is typically formed by the two lowest energy levels. Therefore, transitions between the two lowest energy levels should be implemented reliably while excitation of the higher energy levels should be prevented.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide an arrangement for quantum computing and a quantum computing system. The foregoing and other objectives are achieved by the features of the independent claims. Further implementation forms are apparent from the dependent claims, the description and the figures.

According to a first aspect, an arrangement for quantum computing comprises: a first quantum system having a plurality of Fock quantum states comprising at least a zero-photon state, a one-photon state, and a two-photon state; and a second quantum system coupled to the first quantum system, wherein the second quantum system comprises at least a ground state and one or more excited states and is configured to, via the coupling, cause at least one of the one or more excited states to hybridize with the two-photon state of the first quantum system causing the two-photon state to split into a first hybridized state and a second hybridized state, wherein an energy difference between the one-photon state and the first hybridized state is non-equal to an energy difference between the zero-photon state and the one-photon state and an energy difference between the one-photon state and the second hybridized state is non-equal to the energy difference between the zero-photon state and the one-photon state. The arrangement can, for example, be used as a qubit due to the anharmonicity induced by the coupling.

In an implementation form of the first aspect, the second quantum system is configured to cause the one-photon state of the first quantum system to substantially remain as a Fock state during the coupling.

In another implementation form of the first aspect, the second quantum system comprises a two-level or multi-level quantum system. The arrangement can, for example, utilise the two-level or multi-level quantum system to induce anharmonicity to the first quantum system.

In another implementation form of the first aspect, the second quantum system is configured to not cause any of the one or more excited states to hybridize with the one-photon state of the first quantum system. The arrangement can, for example, be used as a qubit due to the coupling not affecting the one-photon state of the first quantum system.

In another implementation form of the first aspect, without the coupling, the energy difference between the zero-photon state and the one-photon state of the first quantum system is substantially equal to an energy difference between the one-photon state and the two-photon state of the first quantum system. The zero-photon state and the one-photon state of the first quantum system can be used as a qubit computational basis due to the anharmonicity caused by the coupling.

In another implementation form of the first aspect, the first quantum system comprises a substantially harmonic oscillator, a harmonic oscillator, a substantially anharmonic oscillator, or an anharmonic oscillator. The arrangement can, for example, utilise such systems in implementing a qubit.

In another implementation form of the first aspect, the second quantum system is configured to, via the coupling, cause at least one of the one or more excited states to hybridize with the two-photon state of the first quantum system via the at least one excited state being on resonance with the two-photon state. The arrangement can, for example, efficiently implement the coupling by being on resonance.

In another implementation form of the first aspect, the energy difference between the zero-photon state and the one-photon state of the first quantum system corresponds to a first frequency ac, an energy difference between the ground state and at least one excited state of the second quantum system that hybridizes with the two-photon state of the first quantum system corresponds to a second frequency ω_{c}, a coupling strength of the coupling is J, and |2ω_{c}−ω₀|≤J, |2ω_{c}−ω₀|<J, and/or 10×|2ω_{c}−ω₀|<J. The resonance can be implemented efficiently in such an arrangement.

In another implementation form of the first aspect, the first quantum system comprises a lumped-element LC oscillator, a distributed-element LC oscillator, a waveguide resonator, a coplanar waveguide resonator, a half-wavelength resonator, a quarter-wavelength resonator, and/or a three-dimensional cavity resonator. The arrangement can, for example, utilise such components in implementing a qubit.

In another implementation form of the first aspect, the second quantum system comprises at least one superconducting quantum interference device, SQUID, loop and the coupling comprises an inductive coupling between the at least one SQUID loop and the first quantum system. The coupling can be efficiently implemented via the inductive coupling.

In another implementation form of the first aspect, the first quantum system and the second quantum system are coupled via a superconducting element.

In another implementation form of the first aspect, the superconducting element comprises at least one superconducting quantum interference device, SQUID.

In another implementation form of the first aspect, the first quantum system is inductive coupled to the at least one SQUID.

In another implementation form of the first aspect, the superconducting element comprises at least one superconducting nonlinear asymmetric inductive element, SNAIL.

In another implementation form of the first aspect, the first quantum system is capacitively coupled to the at least one SNAIL.

In another implementation form of the first aspect, the second quantum system comprises at least one Josephson junction. The Josephson junction can be used to induce anharmonicity in various ways.

In another implementation form of the first aspect, the second quantum system comprises at least one superconducting qubit. The superconducting qubit can be used to induce anharmonicity in various ways.

In another implementation form of the first aspect, the second quantum system comprises a flux qubit, a split-Cooper-pair-box charge qubit, and/or a transmon qubit. Such devices/components can be used to induce anharmonicity in various ways.

In another implementation form of the first aspect, the coupling is implemented via a unimon or a quarton device, the second quantum system comprises a transmon qubit, the one or more excites states of the transmon qubit further comprise a second lowest excited state, and the second lowest excited state is configured to hybridize with the two-photon state of the first quantum system via the coupling. Such arrangement can effectively induce further anharmonicity via the coupling.

According to a second aspect, a quantum computing system comprises a plurality of arrangements according to the first aspect, wherein each arrangement in the plurality of arrangements is configured as a qubit of the quantum computing system, and wherein the zero-photon state and the one-photon state of the first quantum system are configured to form a computational basis of the qubit.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a schematic representation of an arrangement for quantum computing according to an embodiment;

FIG. 2 illustrates a schematic representation of energy levels of the first quantum system and of a hybridized system according to an embodiment;

FIG. 3 illustrates a schematic representation of energy levels of the second quantum system according to an embodiment;

FIG. 4 illustrates a schematic representation of energy levels of the first and second quantum system according to an embodiment;

FIG. 5 illustrates a circuit diagram representation of an arrangement according to an embodiment;

FIG. 6 illustrates a schematic representation of a phase across a Josephson junction according to an embodiment;

FIG. 7 illustrates a schematic representation of a quantum computing system according to an embodiment; and

FIG. 8 illustrates a schematic representation of a control unit according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

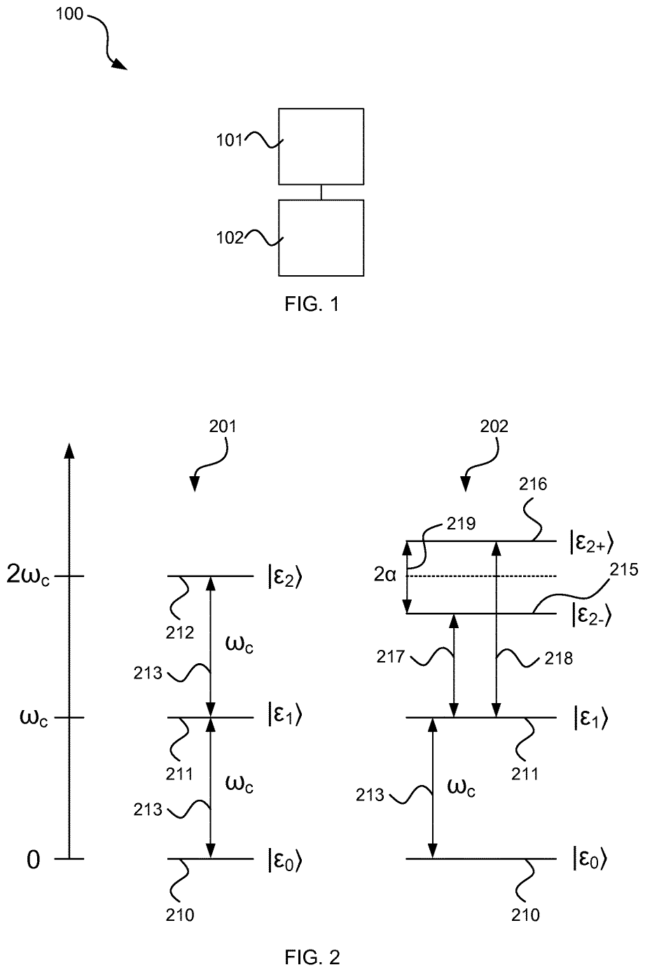

FIG. 1 illustrates a schematic representation of an arrangement 100 for quantum computing according to an embodiment.

According to an embodiment, the arrangement 100 comprises a first quantum system 101 having a plurality of Fock quantum states comprising at least a zero-photon state, a one-photon state, and a two-photon state.

A Fock quantum state may refer to a quantum state corresponding to a well-defined number of particles, such as photons. For example, a n-photon state may refer to a Fock quantum state comprising n photons. Herein, a Fock quantum state may also be referred to as a Fock state, a number state, a number quantum state, or similar.

The first quantum system 101 may correspond to any system/device/component/unit having a plurality of Fock quantum states, such as a harmonic oscillator, an anharmonic oscillator, or similar.

The arrangement 100 may further comprise a second quantum system 102 coupled to the first quantum system, wherein the second quantum system comprises at least a ground state and one or more excited states and is configured to, via the coupling, cause at least one of the one or more excited states to hybridize with the two-photon state of the first quantum system causing the two-photon state to split into a first hybridized state and a second hybridized state, wherein an energy difference between the one-photon state and the first hybridized state is non-equal to an energy difference between the zero-photon state and the one-photon state and an energy difference between the one-photon state and the second hybridized state is non-equal to the energy difference between the zero-photon state and the one-photon state.

The second quantum system 102 may correspond to any system/device/component/unit having at least a ground state and one or more excited states.

Hybridization may refer to a process where two quantum states combine to form a new quantum state. For example, hybridization of the at least one of the one or more excited states of the second quantum system 102 with the two-photon state of the first quantum system 101 results in the first hybridized state and the second hybridized state. The first hybridized state and the second hybridized state may not be eigenstates of the first quantum system 101 or of the second quantum system 102. Rather, they may be eigenstates of the hybridized system formed by the first quantum system 101 and the second quantum system 102.

Herein, when referring to the order of states of, for example, the first quantum system 101 or the second quantum system 102, using phrases such as “lowest”, “second lowest”, and “consecutive”, these terms may refer to the order of the states in terms of energy. For example, the ground state may refer to a lowest state in terms of energy. Similarly, the lowest excited state may refer to an excited state in the one or more excited states with the lowest energy and so on.

Herein, any energy E, such as an energy difference between states, and a corresponding an angular frequency ω may be related by

$$E = ℏω ,$$

where ℏ is the reduced Planck constant. Thus, when an angular frequency ω is disclosed herein, the corresponding energy ℏω is also disclosed. Similarly, when an energy E is disclosed herein, a corresponding angular frequency ω=E/ℏ is also disclosed. Similarly, frequency ν correspond to the angular frequency via ν=ω/(2π). Due to these relations between the quantities, terms such as frequency difference, angular frequency difference, and energy difference may be used interchangeably herein.

Although some embodiments may be disclosed herein with reference to a certain type of implementations of the first 101 and/or second quantum system 102, these implementations are only exemplary. In any embodiment disclosed herein, the first 101 and/or second quantum system 102 may be implemented in various ways and using various technologies.

The arrangement 100 may be embodied in, for example, a quantum computing device. Such a quantum computing device may comprise a plurality of qubits for performing quantum computation. Each such qubit may be implemented using the arrangement 100.

The arrangement 100 may be realized, for example, in the superconducting circuit architecture.

According to an embodiment, the second quantum system 102 comprises a two-level or multi-level quantum system.

A two-level quantum system may refer to a quantum system comprising two quantum states, such as a ground state and one excited state. Similarly, a multi-level quantum system may refer to a quantum system comprising a plurality of quantum states, such as a ground state and a plurality of excited states.

At least some embodiments disclosed herein may overcome limitations in conventional qubit anharmonicity and gate speed.

At least some embodiments disclosed herein may improve fabrication precision in qubit frequency.

At least some embodiments disclosed herein may increase qubit T1 lifetime by increasing the mode volume and removing susceptibility to decay caused by quasiparticle tunnelling.

At least some embodiments disclosed herein may achieve higher anharmonicity, which can make faster quantum gates available.

At least some embodiments disclosed herein may reduce qubit dephasing due to, for example, magnetic noise and charge noise, improving T2 relaxation/dephasing time, which can give more time to perform reliable quantum gates.

At least some embodiments disclosed herein may improve fabrication precision in qubit frequency and thus offer predictable qubit frequencies, which can allow better control of quantum processing unit (QPU) design, more options in making two-qubit gates and possibly fewer flux lines.

FIG. 2 illustrates a schematic representation of energy levels of the first quantum system and of a hybridized system according to an embodiment.

In the embodiment of FIG. 2, energy levels 201 of the first quantum system 101 without the coupling and energy levels 202 of a hybridized system with the coupling are illustrated.

In FIG. 2, the zero-photon state 210, the one-photon state 211, and the two-photon state 212 of the first quantum system 101 are denoted by |ε₀ [symbol] , |ε₁ [symbol] , and |ε₂ [symbol] , respectively.

In the embodiment of FIG. 2, when there is no coupling between the first quantum system 101 and the second quantum system 102, the frequency difference between the zero-photon state 210 and the one-photon state 211 and the frequency difference between the one-photon state 211 and the two-photon state 212 is ω_{c}. The angular frequency ω_{c} corresponds to an energy of ℏω_{c}. Thus, the zero-photon state 210, the one-photon state 211, and the two-photon state are equally spaced in terms of energy.

With the coupling between the first quantum system 101 and the second quantum system 102, the first quantum system 101 and the second quantum system 102 can be considered to form a hybridized system. In the hybridized system, the two-photon state 212 of the first quantum system 101 is effectively split into a first hybridized state |ε₂₋ [symbol] 215 and a second hybridized state |ε₂₊ [symbol] 216 due to the at least one of the one or more excited states of the second quantum system 102 hybridizing with the two-photon state 212 of the first quantum system 101. Due to the splitting, the energy difference 217 between the one-photon state 211 and the first hybridized state 215 is non-equal to an energy difference 213 between the zero-photon 210 state and the one-photon state 211 and an energy difference 218 between the one-photon state 211 and the second hybridized state 216 is non-equal to the energy difference 213 between the zero-photon 210 state and the one-photon state 211.

With the coupling, the two-photon state 212 of the first quantum system 101 can be strongly hybridized with the second quantum system 102. Thus, at least when the coupling is strong, one cannot identify the first hybridized state 215 and the second hybridized state 216 to belong to the first quantum system 101 alone. Rather, the first hybridized state 215 and the second hybridized state 216 should be considered as states of the hybridized system formed by the first quantum system 101 and the second quantum system 102. The zero-photon state 210 and the one-photon state 211 may not be influenced by the coupling and can thus be considered as states of the first quantum system 101.

An energy difference between the first hybridized state |ε₂₋ [symbol] 215 and the two-photon state |ε₂ [symbol] 212 may be α and an energy difference between the second hybridized state |ε₂₊ [symbol] 216 and the two-photon state |ε₂ [symbol] 212 may be α. α may be referred to as the anharmonicity. Thus, the energy difference 219 between the first hybridized state |ε₂₋ [symbol] 215 and the second hybridized state |ε₂₊ [symbol] 216 may be 2α.

With the coupling, the zero-photon state 210 can function as a ground state of a qubit. Herein, the ground state may refer to a quantum state a qubit with the lowest energy.

With the coupling, the one-photon state 211 can function as a lowest excited state of a qubit. Herein, the lowest excited state may refer to a quantum state of a qubit with the second lowest energy.

The zero-photon state 210 and the one-photon state 211 may correspond to the computational basis of the qubit. For example, the zero-photon state 210 may correspond to the |0 [symbol] state of the qubit 101 and the one-photon state 211 may correspond to the |1 [symbol] state of the qubit 101 or vice versa.

According to an embodiment, without the coupling, the energy difference between the zero-photon state 210 and the one-photon state 211 of the first quantum system 101 is substantially equal to an energy difference between the one-photon state 211 and the two-photon state 212 of the first quantum system 101.

Without the coupling, it is difficult to use the first quantum system 101 as a qubit, since the energy difference between the zero-photon state 210 and the one-photon state 211 is substantially equal to an energy difference between the one-photon state 211 and the two-photon state 212. Any attempt to excite the first quantum system 101 from the zero-photon state 210 to the one-photon state 211 can also cause the excitation of the first quantum system 101 from the one-photon state 211 to the two-photon state 212. If the zero-photon state 210 and the one-photon state 211 are used as the computational basis of the qubit, any excitation that causes the qubit to transition to any other state is problematic and can cause leakage errors. With the coupling, this issue can be reduced via the splitting of the two-photon state 212 and the anharmonicity caused by the coupling.

Although only three states are illustrated in the embodiment of FIG. 2, the first quantum system 101 may comprise any number of quantum states. For example, if the first quantum system 101 is implemented using a harmonic oscillator, the first quantum system 101 may comprise a theoretically infinite number of quantum states, wherein each state is an n-photon state. Also higher n-photon states may be split similarly to the two-photon state 212 due to the coupling.

According to an embodiment, the first quantum system 101 comprises a substantially harmonic oscillator, a harmonic oscillator, a substantially anharmonic oscillator, or an anharmonic oscillator.

A harmonic oscillator may refer to a quantum system that can be modelled as having a plurality of quantum states that are equally spaced in terms of energy. A harmonic oscillator may also be referred to as a quantum harmonic oscillator, a linear oscillator, or similar.

A substantially harmonic oscillator may refer to a quantum system that can be modelled as having a plurality of quantum states that are substantially equally spaced in terms of energy.

For example, a drive signal used to excite transitions in a harmonic oscillator practically has a finite non-zero bandwidth. Thus, such as drive signal can be used to drive each transition even when there is a small difference in energy between the transitions, i.e. the oscillator is substantially harmonic.

An anharmonic oscillator may refer to a quantum system that can be modelled as having a plurality of quantum states that are non-equally spaced in terms of energy. The energy difference between consecutive state may follow, for example, a linear or non-linear function. An anharmonic oscillator may also be referred to as a quantum anharmonic oscillator or similar.

A substantially anharmonic oscillator may refer to a quantum system that can be modelled as having a plurality of quantum states that are substantially non-equally spaced in terms of energy. The energy difference between consecutive state may substantially follow, for example, a linear or non-linear function.

According to an embodiment, the first quantum system 101 comprises a weakly anharmonic system. A weakly anharmonic system may refer to a quantum system in which a plurality of states can be populated using a single drive frequency. In a weakly anharmonic system, the deviations from the harmonic energy level structure with equidistant adjacent levels is so small that a drive in resonance with the fundamental frequency can excite the system higher up in energy similar to the harmonic oscillator, since the driving signal practically has a frequency band of finite width around the fundamental frequency. However, the small anharmonicity suppresses this leakage compared to the harmonic oscillator case, especially when the drive power is weak. This allows the use of weakly anharmonic oscillators as qubits. Transmon is an example of a weakly anharmonic oscillator. A weakly anharmonic system may be considered a substantially harmonic oscillator.

According to an embodiment, the second quantum system 102 is configured to not cause any of the one or more excited states to hybridize with the one-photon state 211 of the first quantum system 101.

When any of the one or more excited states do not hybridize with the one-photon state 211 of the first quantum system 101, the one-photon state 211 is not affected by the coupling. Thus, the energy difference between the zero-photon state 210 and the one-photon state 211 is not affected by the coupling. Thus, the one-photon state 211 is not affected by the loss and dephasing channels of the second quantum system 102. Frequency fluctuations of the second quantum system 102 will manifest as anharmonicity fluctuations in the first quantum system 101, which can be considerably less harmful. The first quantum system 101 itself may not comprise a superconducting quantum interference device (SQUID) loop causing dephasing, so the T2 should be improved.

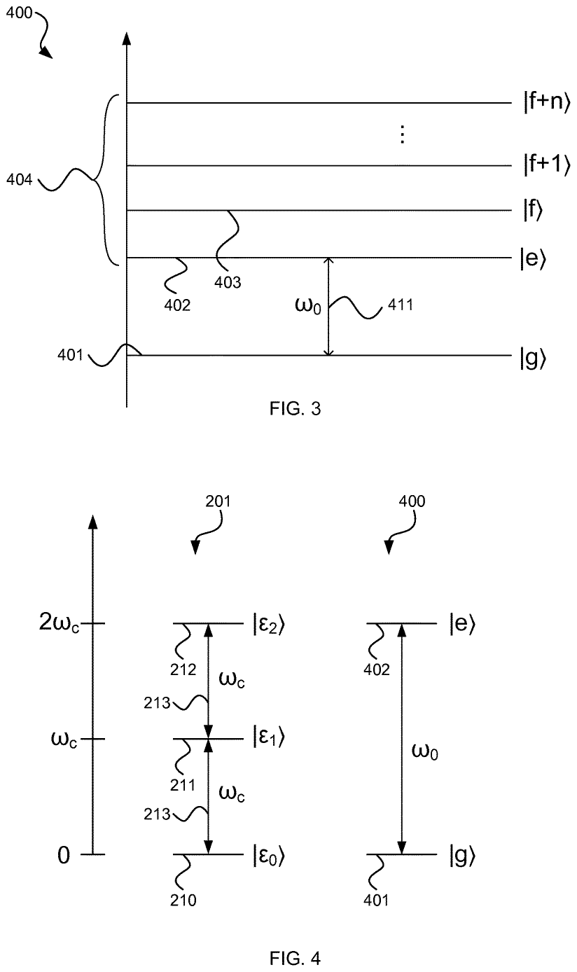

FIG. 3 illustrates a schematic representation of energy levels of the second quantum system according to an embodiment.

The ground state 401 of the second quantum system 102 can be denoted by |g [symbol] .

The one or more excited states 404 of the second quantum system 102 can comprise a lowest excited state 402 that can be denoted by |e [symbol] .

The one or more excited states 404 of the second quantum system 102 may further comprise a second lowest excited state |f [symbol] 403. The second lowest excited state 403 has a higher energy than the ground state 401 and the lowest excited state 402.

Herein, any excited state in the one or more excited states 404 above the second lowest excited state |f [symbol] 403 may be denoted by |f+k [symbol] , where k refers to the position of the state above the second lowest excited state |f [symbol] 403. For example, the third lowest excited state may be denoted by |f+1 [symbol] and so on.

The one or more excited states 404 may comprise any number of excited states. In the embodiment of FIG. 3, four excited states are illustrated. However, as is denoted in FIG. 3, there may be any number of excited states between the state |f+1 [symbol] and the state |f+n [symbol] .

FIG. 4 illustrates a schematic representation of energy levels of the first and second quantum system according to an embodiment.

According to an embodiment, the second quantum system 102 is configured to, via the coupling, cause at least one of the one or more excited states 404 to hybridize with the two-photon state 212 of the first quantum system 101 via the at least one excited state being in resonance with the two-photon state 212.

In the embodiment of FIG. 4 an example of a resonance between the first quantum system 101 and the second quantum system 102 is illustrated. In the embodiment of FIG. 4, ω₀=2ω_{c}. Thus, the lowest excited state 402 of the second quantum system 102 is in resonance with the two-photon state 212 of the first quantum system 101. This type of resonance condition enables three-wave mixing process in which the energy of two photons at frequency ω_{c} in the first quantum system 101 matches the energy of one photon at frequency ω₀ in the second quantum system 102.

The interaction between the first quantum system 101 and the second quantum system 102, when ω₀=2ω_{c}, can be analyzed using the Hamiltonian Ĥ_{2pJC} given by the two-photon Jaynes-Cummings interaction where the two-photon state 212 of the first quantum system 101 hybridizes with the lowest excited state 402 of the second quantum system:

$${\hat{H}}_{2 pJC} = {ω}_{c} {\hat{a}}^{†} \hat{a} + {ω}_{0} {\hat{σ}}_{+} {\hat{σ}}_{-} + J ( {{\hat{a}}^{†}}^{2} {\hat{σ}}_{-} + {\hat{σ}}_{+} {\hat{a}}^{2} ) ,$$

where â^{†} and a refer to the creation and annihilation operators of the first quantum system 101, respectively, \hat{σ}₊ and \hat{σ}₋ refer to the creation and annihilation operators of the second quantum system 102, respectively, and J is the coupling strength of the interactions between the first quantum system 101 and the second quantum system 102. The creation operators may also be referred to as raising ladder operators and the annihilation operators may also be referred to as lowering ladder operators.

The Jaynes-Cummings interaction may apply if, for example, the first quantum system 101 comprises a harmonic oscillator and the second quantum system 102 comprises a qubit, such as a Josephson junction-based qubit.

The anharmonicity α can be set by the coupling strength such that α=\sqrt{2}×J. By designing a strong enough coupling rate J, the zero- 210 and one-photon states 211 of the first quantum system 101 can be considered a two-level system due to the splitting of the two-photon state 212 and thus utilised as a qubit. No excitation of the second quantum system 102 is needed.

Residual single photon coupling does also not enable single photon losses from the first quantum system 101 to the second quantum system 102, especially when they are detuned such that ω₀=2ω_{c}.

According to an embodiment, the energy difference between the zero-photon state and the one-photon state of the first quantum system corresponds to a first frequency ω_{c}, an energy difference between the ground state and at least one excited state of the second quantum system that hybridizes with the two-photon state of the first quantum system corresponds to a second frequency ω₀, a coupling strength of the coupling is J, and |2ω_{c}−ω₀|≤J, |2ω_{c}−ω₀|<J, and/or 10×|2ω_{c}−ω₀|<J.

In the embodiment of FIG. 4, only one possible resonance between the first quantum system 101 and the second quantum system 102 is illustrated. Alternatively, the first 101 and second quantum system 102 may be in resonance in various other ways. For example, any other excited state in the one or more excited states 404 of the second quantum system 102 may be in resonance with the two-photon state 212 of the first quantum system 101.

For example, a four-wave mixing process can be utilised instead of three-wave mixing. In four-wave mixing, the second lowest excited state 403 of the second quantum system 102 can be in resonance with the two-photon state 212 of the first quantum system 101. Thus, the energy of two photons at frequency ω_{c} can match the combined energy of a photon corresponding to the transitions from the ground state 401 to the lowest excited state 402 and a photon corresponding to the transitions from the lowest excited state 402 to the second lowest excited state 403.

Alternatively or additionally, various other n-wave mixing processes can be utilised.

According to an embodiment, the second quantum system 102 is configured to cause the one-photon state 211 of the first quantum system 101 to substantially remain as a Fock state during the coupling.

Herein, the one-photon state 211 substantially remaining as a Fock state during the coupling may mean, for example, that the second quantum system 102 does not cause the one-photon state 211 to split and/or shift significantly. For example, in the embodiment of FIG. 2, the one-photon state 211 is illustrated as unaffected by the coupling between the first quantum system 101 and the second quantum system 102. In other embodiments, the splitting and/or shifting caused by the coupling may be insignificant compared to, for example, the splitting of the two-photon state 212.

The one-photon state 211 may substantially remain as a Fock state when, for example, J/|ω₀−ω_{c}|<2.

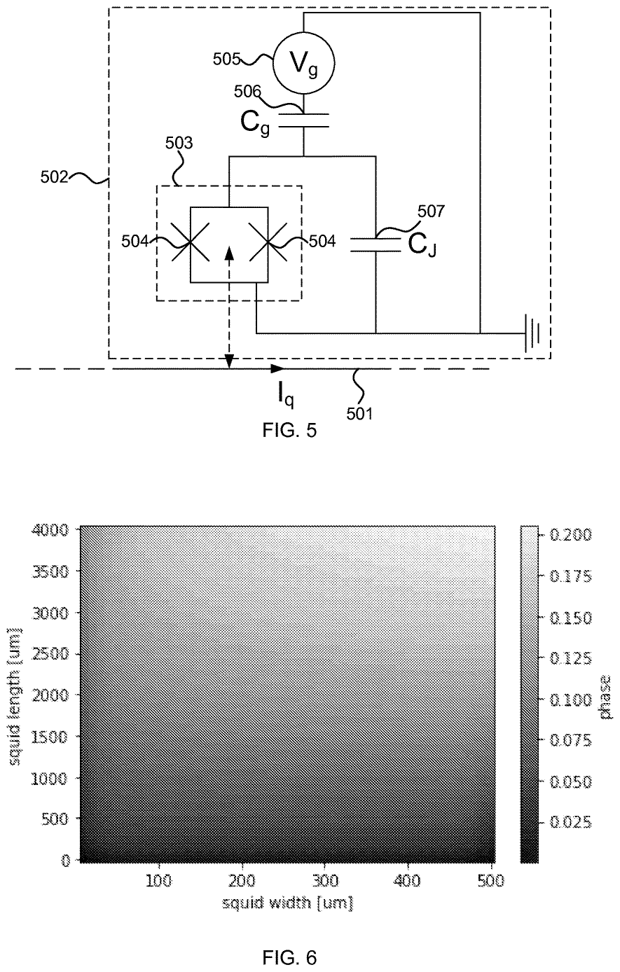

FIG. 5 illustrates a circuit diagram representation of an arrangement according to an embodiment.

In the embodiment of FIG. 5, the first quantum system 101 comprises half-wavelength transmission line resonator 501, the second quantum system 102 comprises a Cooper-pair box 502 with a SQUID loop 503, and the first quantum system 101 is inductively coupled to the second quantum system 102. The SQUID loop 503 comprises two Josephson junctions 504 and is connected to a gate voltage V_{g} 505 via a gate capacitance C_{g} 506. The Cooper-pair box further comprises a capacitance C_{J} 507.

The Cooper-pair box can also be referred to as a charge qubit.

The interaction can be described by the aforementioned Jaynes-Cummings interaction, where the coupling strength is

$$J = {E}_{J}^{0} {ϕ}_{q}^{2} / 2$$

and the anharmonicity is α=\sqrt{2}×J, where

$${E}_{J}^{0}$$

is the Josephson energy of the SQUID loop 503 and φ_{q} is the phase arising from the zero-point fluctuations in the resonator 501. At charge bias n_{g}=0.5, the Cooper-pair box is least sensitive to charge noise and Eⱼ=ω₀. For ω₀=10 GHz, the length of the resonator is one centimetre. φ_{q} can be calculated from the Biot-Savart law. φ_{q}=0.2 gives 283 MHz anharmonicity.

According to an embodiment, the second quantum system 102 comprises at least one Josephson junction 504.

According to an embodiment, the second quantum system 102 comprises at least one superconducting qubit.

According to an embodiment, the second quantum system 102 comprises a flux qubit, a split-Cooper-pair-box charge qubit, and/or a transmon qubit.

According to an embodiment, the first quantum system 101 comprises a lumped-element LC oscillator, a distributed-element LC oscillator, a waveguide resonator, a coplanar waveguide resonator, a half-wavelength resonator, a quarter-wavelength resonator, and/or a three-dimensional cavity resonator.

According to an embodiment, the first quantum system 101 and the second quantum system 102 are coupled via a superconducting element.

The first quantum system 101 may be, for example, galvanically, inductively, or capacitively coupled to the superconducting element.

The second quantum system 102 may be, for example, galvanically, inductively, or capacitively coupled to the superconducting element.

According to an embodiment, the superconducting element comprises at least one SQUID.

According to an embodiment, the first quantum system 101 is inductively coupled to the at least one SQUID.

The second quantum system may be, for example, galvanically or inductively coupled to the at least one SQUID.

According to an embodiment, the superconducting element comprises at least one superconducting non-linear asymmetric inductive element (SNAIL).

According to an embodiment, the first quantum system 101 is capacitively coupled to the at least one SNAIL.

Alternatively, the first quantum system 101 may be, for example, galvanically or inductively coupled to the at least one SNAIL.

The second quantum system 102 may be, for example, galvanically, capacitively, or inductively coupled to the at least one SNAIL.

According to an embodiment, the second quantum system 102 comprises at least one SQUID loop and the coupling comprises an inductive coupling between the at least one SQUID loop and the first quantum system 101.

For example, the first quantum system 101 may comprise a half-wavelength co-planar waveguide (CPW) resonator with two open ends and the second quantum system 102 may comprise a transmon qubit. Alternatively, the half-wavelength CPW resonator may be replaced with a quarter-wavelength resonator or some other length resonator. In principle longer resonators can also be used. Alternatively or additionally, the CPW resonator may be replaced with a three-dimensional cavity resonator or other type of resonator component.

The transmon can be placed close to the middle of the CPW resonator at a current anti-node and a voltage node. Readout can be implemented via capacitive coupling to one end of the CPW resonator. Driving of the CPW resonator can be implemented via capacitive coupling to the other end. The CPW resonator can be inductively coupled to the SQUID loop of a charge qubit at twice the oscillator frequency. The coupling can be implemented at the standing wave current maximum, where the magnetic field pierces the SQUID loop of the qubit, similarly to shown in the embodiment of FIG. 5.

In some embodiments, the CPW can be coupled capacitively to a SNAIL device instead of inductively to a SQUID-based qubit.

In some embodiments, the second quantum system 102 comprises a SQUID loop, the first quantum system 101 comprises a harmonic oscillator, and the coupling comprises an inductive coupling between the SQUID loop and the harmonic oscillator.

In some embodiments, the second quantum system 102 comprises a SNAIL device, the first quantum system 101 comprises a harmonic oscillator, and the coupling comprises capacitive or galvanic coupling between the SNAIL device and the harmonic oscillator.

In some embodiments, the second quantum system 102 comprises a SQUID loop, the first quantum system 101 comprises a flux qubit, and the coupling comprises an inductive coupling between the SQUID loop and the flux qubit.

According to an embodiment, the first quantum system 101 comprises a resonator and/or a cavity. For example, lumped element LC oscillators, distributed element LC oscillators, and waveguide resonators can be modelled as harmonic oscillators when these are implemented using superconducting components.

According to an embodiment, the first quantum system 101 comprises a trapped ion. The trapped ion can be configured to have a plurality of energy levels that are substantially equidistant and thus serve as a substantially harmonic oscillator or a harmonic oscillator.

According to an embodiment, the second quantum system 102 comprises at least one SNAIL and the coupling comprises a capacitive coupling between the at least one SNAIL and the first quantum system.

According to an embodiment, the coupling is implemented via a unimon or a quarton device, the second quantum system 102 comprises a transmon qubit, the one or more excites states of the transmon qubit further comprise a second lowest excited state, and the second lowest excited state is configured to hybridize with the two-photon state of the first quantum system 101 via the coupling.

A unimon device may also be referred to as a unimon or a unimon qubit. A unimon can comprise a Josephson junction shunted by a linear inductor and a capacitor in a parameter regime where the inductive energy is mostly cancelled by the Josephson energy leading to high anharmonicity while being resilient against low-frequency charge noise and partially protected from flux noise. An unimon can be implement as a superconducting circuit by, for example, integrating a single Josephson junction into the center conductor of a superconducting CPW resonator grounded at both ends.

FIG. 6 illustrates a schematic representation of a phase across a Josephson junction according to an embodiment.

In the embodiment of FIG. 6, simulation results for the phase across a Josephson junction is illustrated as a function of SQUID loop width and SQUID loop length for the circuit illustrated in the embodiment of FIG. 5. The phase across the Josephson junction arises from the zero-point fluctuations in the resonator 501. The distance between the SQUID loop and the resonator is 0.1 micrometres.

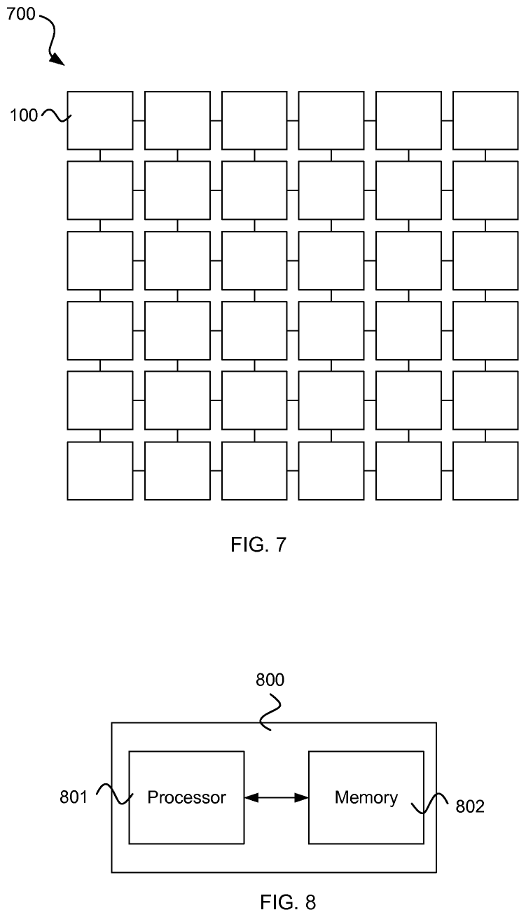

FIG. 7 illustrates a schematic representation of a quantum computing system according to an embodiment.

According to an embodiment, a quantum computing system 700 comprises a plurality of arrangements, wherein each arrangement 100 in the plurality of arrangements is configured as a qubit of the quantum computing system 700, and wherein the zero-photon state 210 and the one-photon state 211 of the first quantum system 101 are configured to form a computational basis of the qubit.

The system 700 may further comprise a control unit configured to control the plurality of arrangements. For example, the control unit may perform quantum computations using the plurality of arrangements.

When the system 700 is operational, each arrangement 100 may be physically located in a cryostat or similar. The cryostat may cool each arrangement 100 and other components of the system 700 to cryogenic temperatures. This may be required if the arrangement 100 comprises, for example, superconducting components.

FIG. 8 illustrates a schematic representation of a control unit 800 according to an embodiment.

The control unit 800 may comprise at least one processor 801. The at least one processor 801 may comprise, for example, one or more of various processing devices, such as a co-processor, a microprocessor, a control unit 800, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The control unit 800 may further comprise a memory 802. The memory 802 may be configured to store, for example, computer programs and the like. The memory 802 may comprise one or more volatile memory devices, one or more non-volatile memory devices, and/or a combination of one or more volatile memory devices and non-volatile memory devices. For example, the memory 802 may be embodied as magnetic storage devices (such as hard disk drives, floppy disks, magnetic tapes, etc.), optical magnetic storage devices, and semiconductor memories (such as mask ROM, PROM (programmable ROM), EPROM (erasable PROM), flash ROM, RAM (random access memory), etc.).

The control unit 800 may further comprise other components not illustrated in the embodiment of FIG. 8. The control unit 800 may comprise, for example, an input/output bus for connecting the control unit 800 to each arrangement 100. Further, a user may control the control unit 800 via the input/output bus. The user may, for example, control quantum computation operations performed by the system 700 100 via the control unit 800 and the input/output bus.

When the control unit 800 is configured to implement some functionality, some component and/or components of the control unit 800, such as the at least one processor 1102 and/or the memory 802, may be configured to implement this functionality. Furthermore, when the at least one processor 801 is configured to implement some functionality, this functionality may be implemented using program code comprised, for example, in the memory 802.

The control unit 800 may be implemented using, for example, a computer, some other computing device, or similar.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An arrangement for quantum computing, comprising:
a first quantum system having a plurality of Fock quantum states comprising at least a zero-photon state, a one-photon state, and a two-photon state; and
a second quantum system coupled to the first quantum system, wherein the second quantum system comprises at least a ground state and one or more excited states and is configured to, via the coupling, cause at least one of the one or more excited states to hybridize with the two-photon state of the first quantum system causing the two-photon state to split into a first hybridized state and a second hybridized state, wherein an energy difference between the one-photon state and the first hybridized state is non-equal to an energy difference between the zero-photon state and the one-photon state and an energy difference between the one-photon state and the second hybridized state is non-equal to the energy difference between the zero-photon state and the one-photon state;
wherein the energy difference between the zero-photon state and the one-photon state of the first quantum system corresponds to a first frequency ω_{c}, an energy difference between the ground state and at least one excited state of the second quantum system that hybridizes with the two-photon state of the first quantum system corresponds to a second frequency ω₀, a coupling strength of the coupling is J, and |2ω_{c}−ω₀|≤J.

2. The arrangement of claim 1, wherein the second quantum system is configured to cause the one-photon state of the first quantum system to substantially remain as a Fock state during the coupling.

3. The arrangement of claim 1, wherein the second quantum system comprises a two-level or multi-level quantum system.

4. The arrangement of claim 1, wherein the second quantum system is configured to not cause any of the one or more excited states to hybridize with the one-photon state of the first quantum system.

5. The arrangement of claim 1, wherein without the coupling between the second quantum state and the first quantum state, the energy difference between the zero-photon state and the one-photon state of the first quantum system is substantially equal to an energy difference between the one-photon state and the two-photon state of the first quantum system.

6. The arrangement of claim 1, wherein the first quantum system comprises a substantially harmonic oscillator, a harmonic oscillator, a substantially anharmonic oscillator, or an anharmonic oscillator.

7. The arrangement of claim 1, wherein the second quantum system is configured to, via the coupling between the second quantum state and the first quantum state, cause at least one of the one or more excited states to hybridize with the two-photon state of the first quantum system via the at least one excited state being in resonance with the two-photon state.

8. The arrangement of claim 1, wherein |2ω_{c}−ωₒ|<J and/or 10×|2ω_{c}−ωₒ|<J.

9. The arrangement of claim 1, wherein the first quantum system comprises a lumped-element LC oscillator, a distributed-element LC oscillator, a waveguide resonator, a coplanar waveguide resonator, a half-wavelength resonator, a quarter-wavelength resonator, and/or a three-dimensional cavity resonator.

10. The arrangement of claim 1, wherein the first quantum system and the second quantum system are coupled via a superconducting element.

11. The arrangement of claim 10, wherein the superconducting element comprises at least one superconducting quantum interference device (SQUID).

12. The arrangement of claim 11, wherein the first quantum system is inductive coupled to the at least one SQUID.

13. The arrangement of claim 10, wherein the superconducting element comprises at least one superconducting nonlinear asymmetric inductive element (SNAIL).

14. The arrangement of claim 13, wherein the first quantum system is capacitively coupled to the at least one SNAIL.

15. The arrangement of claim 1, wherein the second quantum system comprises at least one Josephson junction.

16. The arrangement of claim 1, wherein the second quantum system comprises at least one superconducting qubit.

17. The arrangement of claim 1, wherein the second quantum system comprises a flux qubit, a split-Cooper-pair-box charge qubit, and/or a transmon qubit.

18. The arrangement of claim 1, wherein the coupling between the second quantum state and the first quantum state is implemented via a unimon or a quarton device, the second quantum system comprises a transmon qubit, the one or more excites states of the transmon qubit further comprise a second lowest excited state, and the second lowest excited state is configured to hybridize with the two-photon state of the first quantum system via the coupling between the second quantum state and the first quantum state.

19. A quantum computing system comprising a plurality of arrangements according to claim 1, wherein each arrangement in the plurality of arrangements is configured as a qubit of the quantum computing system, and wherein the zero-photon state and the one-photon state of the first quantum system are configured to form a computational basis of the qubit.
